(19) United States
(12) Patent Application Publication
(10) Pub. No.: US 2025/0172446 A1
(43) Pub. Date: May 29, 2025

(54) FORCE SENSOR HAVING CONTACT MEMBER AND ANNULAR FORCE SENSING DEVICE INCLUDING THE SAME

(71) Applicant: INDUSTRIAL TECHNOLOGY RESEARCH INSITITUTE, Hsinchu (TW)

(72) Inventors: Che-Kai Yeh, Tainan City (TW); Hua-Lun Chi, Taichung City (TW); Tzung-Ching Lee, Hsinchu County (TW); Chao-Ta Huang, Hsinchu City (TW)

(21) Appl. No.: 18/752,953

(22) Filed: Jun. 25, 2024

(30) Foreign Application Priority Data
Nov. 29, 2023 (TW) 112146431

(51) Int. Cl. G01L 5/00; G01L 5/166

(52) U.S. Cl. CPC G01L 5/0019; G01L 5/166

(57) ABSTRACT

A force sensor having a contact member and an annular force sensing device including the same are provided. The force sensor comprises a bearing member with several bearing surfaces forming a multi-sided recess, a restraint member coupled to the bearing member and having a through hole, a contact member positioned within the multi-sided recess and protruding through the hole, and several sensing members disposed on or within the bearing member. Each sensing member corresponds to a specific bearing surface and has a sensing direction perpendicular to that surface. The annular force sensing device includes a ring and at least one of the force sensors, which can be arranged on the inner surface of the ring.

### CROSS-REFERENCE TO RELATED APPLICATION

This non-provisional application claims priority under 35 U.S.C. § 119 (a) to patent application No. 112146431 filed in Taiwan, R.O.C. on Nov. 29, 2023, the entire contents of which are hereby incorporated by reference.

### BACKGROUND

### Technical Field

The disclosure relates to a force sensor having a contact member and an annular force sensing device including the same.

### Related Art

Both in the manufacturing and construction of large objects and in the operation of heavy machinery, stress and deformation monitoring mechanisms are crucial. Take the wind energy industry as an example. During the construction of a tower, a force sensor is commonly used to measure the impact force on the pile and to detect the deformation of the pile. Similarly, during stable operation of a wind turbine, a force sensor can be used to continuously monitor the deformation of the tower.

Current methods for monitoring deformation of a pile often rely on invasive sensing. This means the pile is drilled or cut in order to embed a sensor. However, this destructive technique can induce stress concentrations that increases the risk of damage of the pile. Additionally, replacing or repairing the sensor embedded in the pile becomes a challenge after installation. Another limitation is the potential for reduced accuracy and sensitivity of the sensor. Moreover, when the pile is subjected to a load, the deformation in the radial direction may be different at different positions on the cross section of the pile. This may result in the radial force on the cross-section of the pile being transmitted to the force sensor at angles that are not perpendicular to the sensing surface of the force sensor, thereby reducing the accuracy and sensitivity of the sensor.

To further explain, please refer to FIG. 9, which is a schematic diagram of the component forces of the oblique force Fy sensed by the force sensor 4 known to the inventor. In FIG. 9, “oblique force Fy” refers to a force that is not perpendicular to the sensing surface 41 of the force sensor 4 known to the inventor. As shown in the figure, when the oblique force Fy is applied to the force sensor 4, only the longitudinal component force fv is detected. The transverse component force fn is not detected because it is not perpendicular to the sensing surface 41. Consequently, when the force sensor 4 known to the inventor senses the oblique force Fy, the sensing result will lack at least one component force, significantly affecting the accuracy and sensitivity of the detection.

### SUMMARY

In view of this, according to some embodiments, a force sensor is provided to accurately detect deformation and measure force. According to some embodiments, an annular force sensing device including the same is provided.

A force sensor according to an embodiment of the disclosure includes a bearing member, a restraint member, a contact member, and a plurality of sensing members. The bearing member includes a multi-sided recess. The restraint member with a through hole is coupled to the bearing member. The contact member is disposed in the multi-sided recess, wherein the contact member contacts a plurality of bearing surfaces of the multi-sided recess and has an exposed portion protruding from the through hole. The plurality of sensing members are respectively disposed on the plurality of bearing surfaces or disposed within the bearing member; and the plurality of sensing members correspond to the plurality of bearing surfaces. Each of the plurality of sensing members has a sensing direction perpendicular to a corresponding one of the plurality of bearing surfaces.

An annular force sensing device according to an embodiment of the disclosure includes a ring and a force sensor. The force sensor may be arranged on an inner surface of the ring. In some embodiments, for the force sensor, reference may be made to the previous paragraph.

A force sensor according to an embodiment of the disclosure includes a bearing member, a plurality of sensing members, and a contact member. The bearing member includes a plurality of bearing surfaces. The plurality of sensing members are respectively disposed on the bearing surfaces, or disposed within the bearing member and respectively correspond to the bearing surfaces. Each of the sensing members has a sensing direction perpendicular to a corresponding one of the plurality of bearing surfaces. The contact member includes a force applying portion and a plurality of contact portions. The force applying portion is capable of contact with a measured object, and the plurality of contact portions are in point contact or line contact with the bearing surfaces of the bearing member.

The summary presented above does not include an exhaustive list of all aspects of the disclosure. It is provided merely to introduce certain concepts and not to identify any key or essential features of the claimed subject matters.

### BRIEF DESCRIPTION OF THE DRAWINGS

FIG. 1A illustrates a perspective view of a force sensor according to an embodiment of the disclosure.

FIG. 1B illustrates a cross-sectional view along line A-A in FIG. 1A.

FIG. 1C illustrates a schematic diagram illustrating the applied force, the first component force, and the second component force in FIG. 1B.

FIG. 1D illustrates a cross-sectional view of a force sensor according to an embodiment of the disclosure.

FIG. 1E illustrates a cross-sectional view of a force sensor according to an embodiment of the disclosure.

FIG. 1F illustrates a cross-sectional view of a force sensor according to an embodiment of the disclosure.

FIG. 2A illustrates a perspective view of a force sensor according to an embodiment of the disclosure.

FIG. 2B illustrates a front view of the force sensor shown in FIG. 2A.

FIG. 2C illustrates a schematic diagram illustrating the applied force, the first component force, and the second component force in FIG. 2B.

FIG. 2D illustrates an exploded view of a sensing member in the force sensor shown in FIG. 2B.

FIG. 3A illustrates a perspective view of a force sensor according to an embodiment of the disclosure.

FIG. 3B illustrates a partially exploded view of the force sensor shown in FIG. 3A.

FIG. 4A illustrates a perspective view of a force sensor according to an embodiment of the disclosure.

FIG. 4B illustrates a partially exploded view of the force sensor shown in FIG. 4A.

FIG. 5 illustrates a perspective view of an annular force sensing device according to an embodiment of the disclosure.

FIG. 6A illustrates a perspective view of an annular force sensing device according to an embodiment of the disclosure.

FIG. 6B illustrates a schematic diagram illustrating the application of the annular force sensing device shown in FIG. 6A to a wind turbine.

FIG. 7A illustrates a top view of the annular force sensing device shown in FIG. 6B, where a measured object is presented as a section and is in an undeformed state.

FIG. 7B illustrates a cross-sectional view of a force sensor in the annular force sensing device shown in FIG. 7A.

FIG. 7C illustrates a schematic diagram illustrating the applied force, the first component force, and the second component force in FIG. 7B.

FIG. 8A illustrates a top view of the annular force sensing device shown in FIG. 6B, where a measured object is presented as a section and is in a deformed state.

FIG. 8B illustrates a cross-sectional view of a force sensor in the annular force sensing device shown in FIG. 8A.

FIG. 8C illustrates a schematic diagram illustrating the applied force, the first component force, and the second component force in FIG. 8B.

FIG. 9 illustrates a schematic diagram of a component force when a force sensor known to the inventor senses an oblique force.

### DETAILED DESCRIPTION

Various embodiments are described in detail below. However, the embodiments are merely used as examples for description and do not limit or narrow the protection scope of the disclosure. In addition, some elements are omitted in the drawings of the embodiments to clearly show the technical features of the disclosure. Further, identical reference numeral is used for indicating the same or similar elements in all of the drawings. Drawings of the disclosure are only illustrative, which are not necessarily drawn to scale, and all details are not necessarily presented in the drawings.

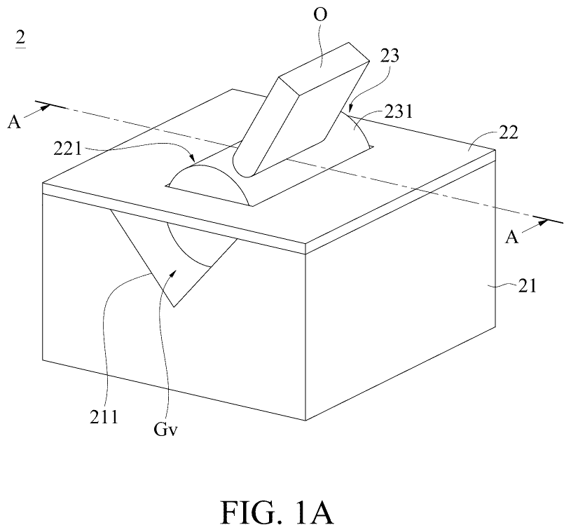

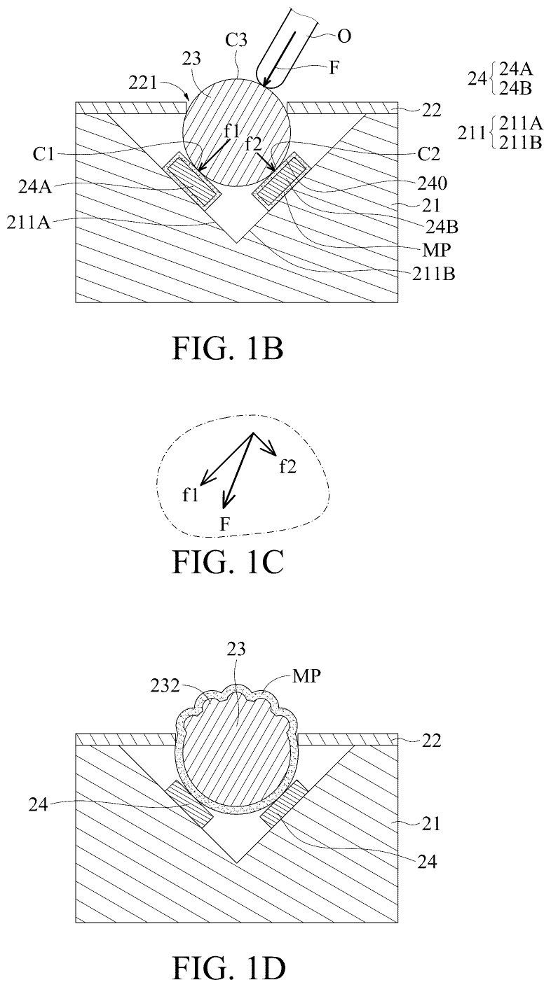

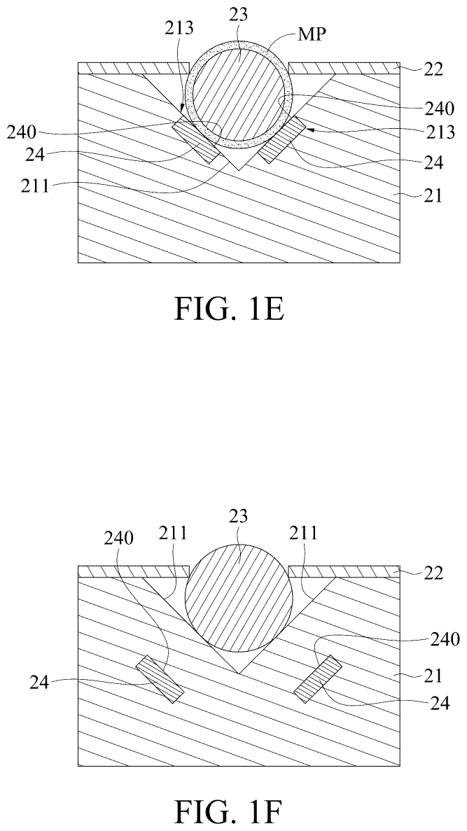

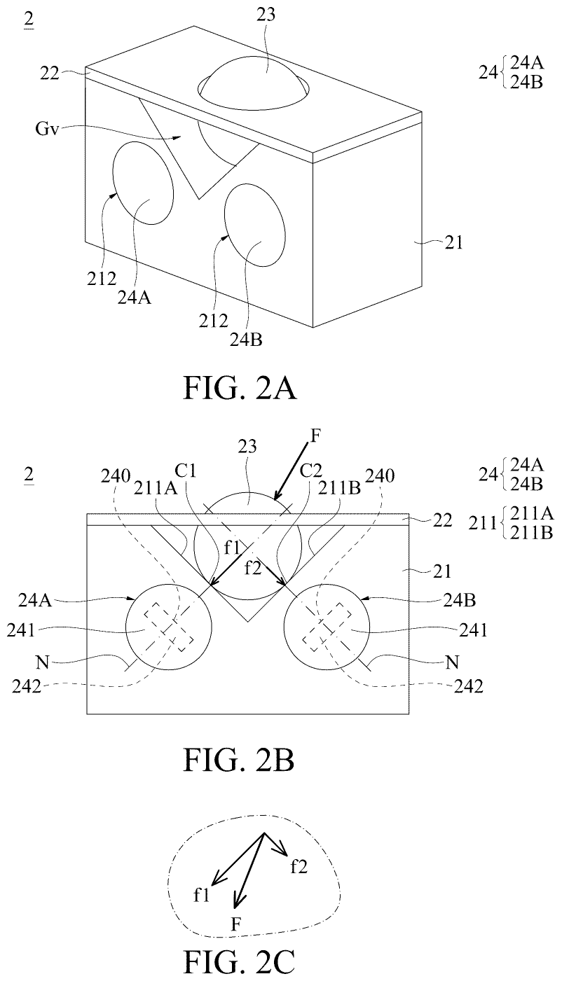

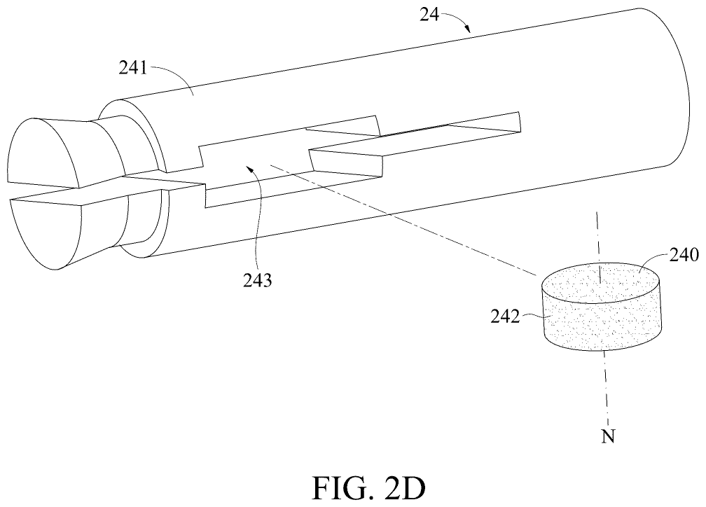

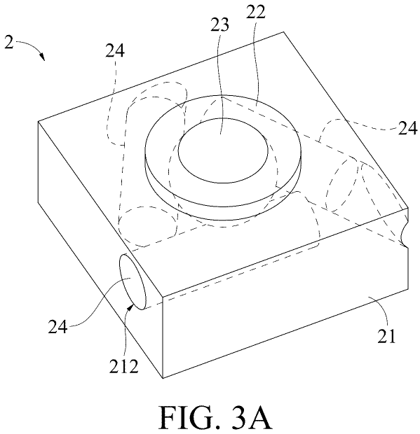

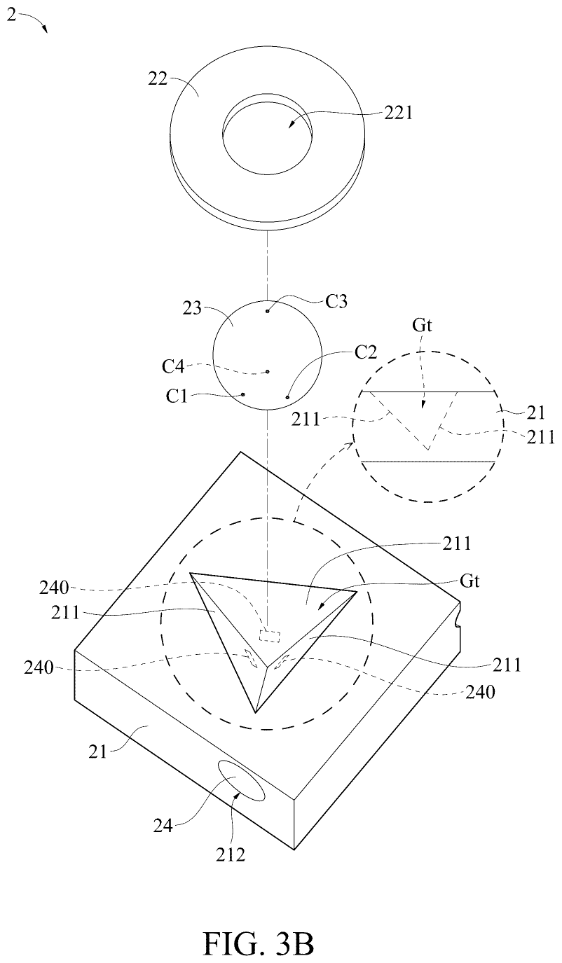

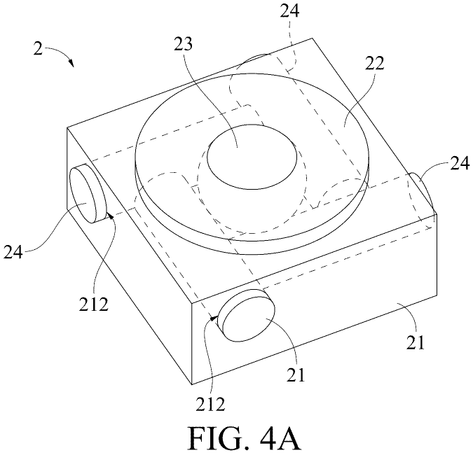

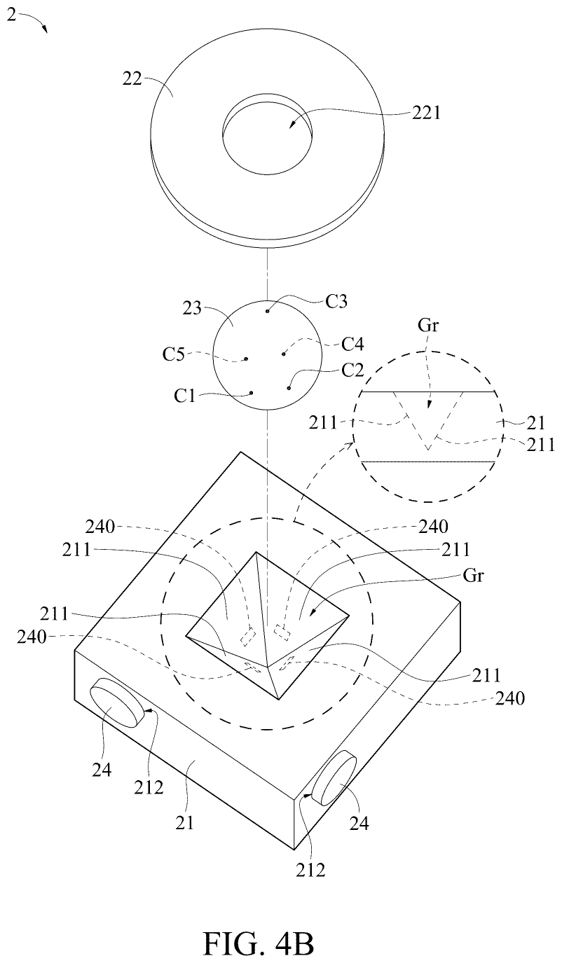

Refer to FIG. 1A and FIG. 1B together. FIG. 1A illustrates a perspective view of a force sensor 2 according to an embodiment of the disclosure. FIG. 1B illustrates a cross-sectional view along line A-A in FIG. 1A. As shown in the figure, an embodiment of the force sensor 2 includes a bearing member 21, a restraint member 22, a contact member 23, and a plurality of sensing members 24. The plurality of sensing members 24 shown in FIG. 1B includes a first sensing member 24A and a second sensing member 24B. In some embodiments, the bearing member 21 is a cuboid provided with a multi-sided recess recessed from an upper surface of the bearing member 21. In some embodiments, the multi-sided recess may be a V-shaped groove Gv, and the V-shaped groove Gv is formed by two bearing surfaces 211 (for example, FIG. 2A). In another embodiment, the multi-sided recess may alternatively be a three-sided pyramidal recess (for example, triangularly pyramidal recess in FIG. 3B), a four-sided pyramidal recess (for example, quadrilaterally pyramidal recess in FIG. 4B), or another multi-sided recess.

In some embodiments, the included angle between the two bearing surfaces 211 of the V-shaped groove Gv is ninety degrees. The term “ninety degrees” mentioned here refers to a substantial angle of “ninety degrees.” It is intended that the provided numerical value includes a manufacturing or operational tolerance (e.g., ±10%) around the specified angle. The contact member 23 is a cylinder located in the V-shaped groove Gv, and part of the contact member 23 protrudes from the V-shaped groove Gv. In this embodiment, more than half of the volume of the contact member 23 is located in the V-shaped groove Gv. It should be noted that the contact member 23 may alternatively be of other types, such as a sphere (like FIG. 2A), a multi-sided member, or a member whose surface is provided with a plurality of protrusions (like FIG. 1D), as long as it can resolve the applied force into component forces which are applied on sensing members 24. The contact member 23 may be made of a metal material, such as stainless steel.

The restraint member 22 with a through hole 221 is an upper cover plate arranged on the upper surface of the bearing member 21. In this embodiment, the through hole 221 is a rectangular through hole having an opening width smaller than a maximum width of the contact member 23. In addition, the opening widths of the through hole 221 on the upper surface and the lower surface of the restraint member 22 are the same. To be specific, two side walls of the through hole 221 are parallel. The term “parallel” mentioned here refers to a substantially parallel orientation. It is intended that the associated numerical value includes a manufacturing or operational tolerance (e.g., ±10%) around the specified orientation. Taking the cylindrical contacting member 23 as an example, the opening width of the through hole 221 is smaller than the diameter of the cross-section of the cylindrical contacting member 23. Therefore, the contact member 23 is confined within the V-shaped groove Gv, and it may be ensured that the contact member 23 always contacts each bearing surface 211.

In addition, the contact member 23 has an exposed portion 231 protruding through the through hole 221 of the restraint member 22. The exposed portion 231 is a convex curved surface forming a force applying surface for contacting a measured object O. In addition, in another embodiment, a surface of the exposed portion 231 may also include a plurality of protrusions 232, as shown in FIG. 1D, which may be applicable to the measured object O with an irregular surface.

In some embodiments, the first sensing member 24A and the second sensing member 24B may be piezoelectric sensing elements capable of generating electrical signals based on the loads to which they are subjected These signals can be used to detect deformation and measure force. However, the first sensing member 24A and the second sensing member 24B are not limited to the piezoelectric sensing elements. Any force sensing element capable of detecting applied force or any deformation sensing element capable of detecting deformation is applicable.

In addition, as shown in FIG. 1B, the first sensing member 24A is located on the bearing surface 211A, and the second sensing member 24B is located on the bearing surface 211B. Generally, each bearing surface 211 may be provided with a sensing member 24. However, in other embodiments, for example, in the case where the bearing surface 211 has a large area or when more precise sensing is required, multiple sensing members 24 can also be configured on each bearing surface 211.

Moreover, in the embodiment shown in FIG. 1B, the first sensing member 24A and the second sensing member 24B are respectively arranged on the bearing surfaces 211A, 211B. A sensing direction of each sensing member 24 is perpendicular to its respective bearing surface 211. The term “perpendicular” mentioned here refers to a substantially perpendicular orientation. It is intended that the associated numerical value includes a manufacturing or operational tolerance (e.g., 10%) around the specified orientation. Furthermore, the first sensing member 24A and the second sensing member 24B are directly in contact with the contact member 23. In an embodiment, to protect the first sensing member 24A and the second sensing member 24B, a cladding material MP may cover the surfaces of the first sensing member 24A and the second sensing member 24B. The cladding material MP may be made of an elastic material, such as but not limited to rubber or silicone. In other embodiments, to achieve the purpose of protecting the first sensing member 24A and the second sensing member 24B, the cladding material MP may also be arranged on the surface of the contact member 23, as shown in FIG. 1D and FIG. 1E.

Still referring to FIG. 1B, the contact member 23 includes a first contact portion C1, a second contact portion C2, and a force applying portion C3. The first contact portion C1 and the second contact portion C2 are configured for point or line contact with the sensing surfaces 240 of the first sensing member 24A and the second sensing member 24B on respective bearing surfaces 211. The force applying portion C3 is configured for point or line contact with the measured object O. In this embodiment, the first contact portion C1 and the second contact portion C2 make line contact with the sensing surfaces 240, and the force applying portion C3 also makes line contact with the measured object O.

In addition, when a position at which the measured object O contacts the contact member 23 changes, the position at which the force applying portion C3 contacts the measured object O changes accordingly. In this case, the direction of the applied force F applied to the contact member 23 also changes. However, when the direction of the applied force F applied to the contact member 23 changes, the position where the first contact portion C1 contacts the sensing surface 240 and the position where the second contact portion C2 contacts the sensing surface 240 do not change. In other words, the positions of the line contacts between the first contact portion C1 and the sensing surface 240 and between the second contact portion C2 and the sensing surface 240 remain unchanged.

In addition, referring to FIG. 1C together, FIG. 1C illustrates a schematic diagram illustrating the applied force F, the first component force f1, and the second component force f2 in FIG. 1B. As shown in FIG. 1B and FIG. 1C, when the measured object O is deformed due to an external force, a resulting applied force F is applied to the force applying portion C3 of the contact member 23. The contact member 23 then applies a first component force f1 to the first sensing member 24A through the first contact portion C1 of the contact member 23, and applies a second component force f2 to the second sensing member 24B through the second contact portion C2 of the contact member 23. Here, the first component force f1 is applied to the first sensing member 24A in a direction perpendicular to the sensing surface 240 of the first sensing member 24A, and the second component force f2 is applied to the second sensing member 24B in a direction perpendicular to the sensing surface 240 of the second sensing member 24B.

Therefore, as long as the first component force f1 and the second component force f2 are respectively measured by the first sensing member 24A and the second sensing member 24B, a resultant force composed of first component force f1 and the second component force f2 may be calculated. Therefore, a magnitude and a direction of the applied force F applied to the contact member 23 may be obtained. From the above embodiment, it is evident that no component force is neglected, and the magnitude and direction of the applied force F can be accurately measured.

Referring to FIG. 1E, FIG. 1E illustrates a cross-sectional view of a force sensor 2 according to an embodiment of the disclosure. As shown in this figure, each bearing surface 211 has an installation slot 213 for accommodating and positioning a sensing member 24. In addition, only the sensing surface 240 of the sensing member 24 is exposed, and other parts of the sensing member 24 are buried in the installation slot 213 to protect the sensing member 24.

Referring to FIG. 1F, FIG. 1F illustrates a cross-sectional view of a force sensor 2 according to an embodiment of the disclosure. In the embodiment shown in FIG. 1F, the sensing members 24 are embedded within the bearing member 21. Each sensing member 24 corresponds to a bearing surface 211. A sensing surface 240 of the sensing member 24 faces the bearing surface 211 and is parallel to the bearing surface 211. A sensing direction of the sensing member 24 is perpendicular to its corresponding bearing surface 211. The terms “parallel” and “perpendicular” mentioned here refer to a substantially parallel and a substantially perpendicular orientation. It is intended that the associated numerical value includes a manufacturing or operational tolerance (e.g., ±10%) around the specified orientation. As the sensing members 24 are configured in the bearing member 21, the sensing members 24 do not directly contact the contact member 23, which may reduce the risk of damage from bearing an excessive component force directly. In addition, since the contact member 23 does not directly contact the sensing members 24, the component forces applied by the contact member 23 are transmitted to the sensing members 24 through the bearing surfaces 211 and the bearing member 21.

Refer to FIG. 2A to FIG. 2D together. FIG. 2A illustrates a perspective view of a force sensor 2 according to an embodiment of the disclosure. FIG. 2B illustrates a front view of the force sensor 2 shown in FIG. 2A. FIG. 2C illustrates a schematic diagram illustrating the applied force F, the first component force f1, and the second component force f2 in FIG. 2B. FIG. 2D illustrates an exploded view of a sensing member 24 in the force sensor 2 shown in FIG. 2B. In the embodiment shown in the drawings, the contact member 23 is a sphere, such as a steel ball. However, because the sphere can roll, during installation, the force sensor 2 may move or rotate along the surface of the measured object O to find an optimal position or orientation for installation.

In some embodiments, the sensing member 24 may be modularized, as shown in FIG. 2D, for easier installation, replacement, and maintenance. In the embodiment shown in FIG. 2D, each sensing member 24 includes a housing 241 and a piezoelectric unit 242; the housing 241 is a cylindrical structure with an accommodating groove 243. During installation of the sensing member 24, the piezoelectric unit 242 is first placed in the accommodating groove 243, and then the housing 241 is inserted into a pre-formed insertion hole 212 in the bearing member 21 (see FIG. 2A). In this embodiment, the bearing member 21 and the housing 241 may be made of the same material or different materials.

In addition, since the contact member 23 in this embodiment is a sphere, a point contact is formed between the contact member 23 and each bearing surface 211, and a position of the point contact is stationary. In other words, the positions of the point contacts between the contact member 23 and the bearing surfaces 211 will not change when the contact member 23 rolls. In addition, in this embodiment, the sensing member 24 is arranged inside the bearing member 21, and the contact member 23 is in direct contact with the bearing surfaces 211 in the V-shaped groove Gv. When the contact member 23 generates two component forces due to the applied force F, these component forces are respectively applied to the bearing surfaces 211 and then separately transmitted to the sensing members 24 through the bearing member 21.

To further explain, referring to FIG. 2B and FIG. 2C together, when the contact member 23 is subjected to the applied force F, the applied force F is divided into two component forces, i.e. the first component force f1 and the second component force f2. Subsequently, the first component force f1 is applied to the bearing surface 211A corresponding to the first sensing member 24A, and the second component force f2 is applied to the bearing surface 211B corresponding to the second sensing member 24B. Then, these component forces f1, f2 are respectively transmitted to the piezoelectric units 242 inside the first sensing member 24A and the second sensing member 24B through the bearing member 21 and the housing 241 of the sensing member 24. Finally, by measuring the first component force f1 and the second component force f2 respectively with the first sensing member 24A and the second sensing member 24B, the magnitude and the direction of the applied force F applied to the contact member 23 may be calculated.

In addition, in the embodiment shown in FIG. 2A to FIG. 2D, the normal line N of the sensing surface 240 of each sensing member 24 passes through the corresponding bearing surface 211 and the centroid of the contact member 23. This ensures that each sensing member 24 can accurately and sensitively measure the force applied to the bearing surfaces 211. To further explain, if the normal line N of the sensing surface 240 does not pass through the centroid of the contact member 23, for example, when the normal line N of the sensing surfaces 240 of the sensing members 24 do not completely coincide with the line of action of the first component force f1 applied to the bearing surface 211A or the line of action of the second component force f2 applied to the bearing surface 211B, a sensing error or a decrement in measurement sensitivity may occur.

Refer to FIG. 3A and FIG. 3B. FIG. 3A illustrates a perspective view of a force sensor 2 according to an embodiment of the disclosure. FIG. 3B illustrates a partial exploded view of the force sensor 2 shown in FIG. 3A, which shows a state where the restraint member 22 and the contact member 23 are separated from the bearing member 21. As shown in FIG. 3A and FIG. 3B, the bearing member 21 has a three-sided pyramidal recess Gt having three bearing surfaces 211 and extending from an upper surface of the bearing member 21 to interior of the bearing member 21. Inside the bearing member 21, a sensing member 24 is configured on each bearing surface 211. The sensing members 24 may be of the type shown in FIG. 2D and are arranged in the insertion hole 212 on the side walls of the bearing member 21. In addition, FIG. 3B also shows a partially enlarged side view to present a recessed state of the three-sided pyramidal recess Gt.

The arrangement of the three-sided pyramidal recess Gt is used in this embodiment, where the side edges of the bearing surfaces 211 are connected to each other at a specific angle. To be specific, an included angle is formed between each bearing surface 211 and the adjacent bearing surface 211. The sensing surfaces 240 of all sensing members 24 are also set to be parallel to their corresponding bearing surfaces 211. The contact member 23 includes a first contact portion C1, a second contact portion C2, and a third contact portion C4, each of which makes point contact with the bearing surfaces 211 of the three-sided pyramidal recess Gt. Therefore, when each sensing member 24 measures the component force on the sensing surface 240, the magnitude and the direction of the applied force F applied to the contact member 23 may be obtained.

Refer to FIG. 4A and FIG. 4B together. FIG. 4A illustrates a perspective view of a force sensor 2 according to an embodiment of the disclosure. FIG. 4B illustrates a partial exploded view of the force sensor 2 shown in FIG. 4A, which shows a state in which a restraint member 22 and a contact member 23 are separated from a bearing member 21. In addition, FIG. 4B additionally shows a partially enlarged side view to present a recessed state of a four-sided pyramidal recess Gr. In this embodiment, the multi-sided recess is a four-sided pyramidal recess Gr and the number of the sensing members 24 is four. In other words, the four-sided pyramidal recess Gr has four bearing surfaces 211, with each bearing surface 211 corresponding to a sensing member 24. Each bearing surface 211 has an angle with the adjacent bearing surface 211. The contact member 23 includes a first contact portion C1, a second contact portion C2, a third contact portion C4, and a fourth contact portion C5, each of which contacts the bearing surfaces 211 of the four-sided pyramidal recess Gr. It should be noted that the contact between each bearing surface 211 and the contact member 23 should be point contact or the contact area should be as small as possible, to enhance the measurement accuracy and sensitivity of the force sensor 2.

In some embodiments, the force sensor 2 can be configured to measure a force from a single direction, or it can be configured to measure forces from a plurality of directions. In some embodiments, the configuration of a measured object O may be any type, such as a plate, a rack, a barrel, a block, a beam, a column, a pile, a shaft, a rod, and a bar. In addition, the force sensor 2 may be directly or indirectly mounted to a surface of the measured object O. Indirect mounting refers to configuring the force sensor 2 on other fixtures first, such as a ring, a frame, a seat, or a rack and then securing the fixture to the measured object O by means of screws, welding, gluing, magnetic attraction, or other fixing methods.

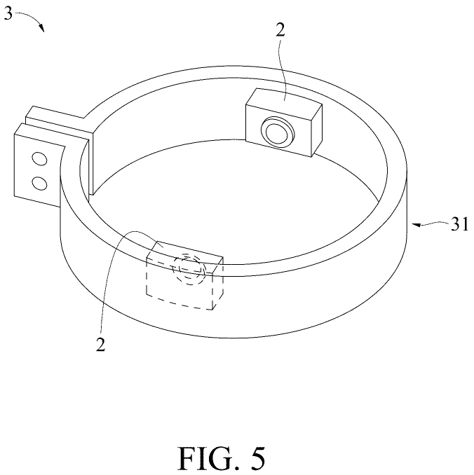

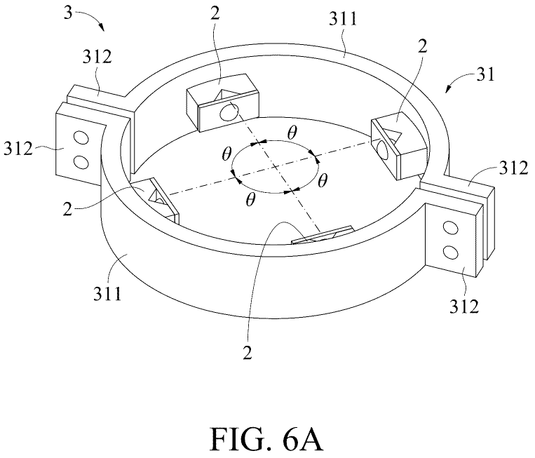

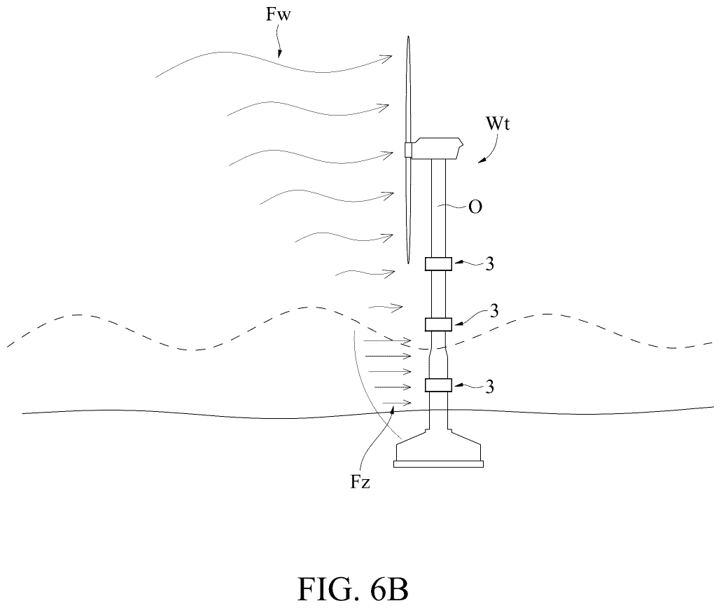

Refer to FIG. 5. This figure presents a perspective view of an annular force sensing device 3 according to an embodiment of the disclosure. It illustrates the formation of an annular force sensing device 3 by placing the force sensors 2 on the ring 31. Specifically, after configuring the force sensors 2 on the inner surface of the ring 31, an annular force sensing device 3 is formed. Once the annular force sensing device 3 is disposed onto the measured object O (as seen in FIG. 6B), it can measure the force applied to the force sensor 2 and detect any deformation of the measured object O (as seen in FIG. 6B).

In some embodiments, the annular force sensing device 3 may be configured with one or more force sensors 2. When a single force sensor 2 is configured, the annular force sensing device 3 may measure the force on one side or at a specific point of the measured object O (shown in FIG. 6B). For example, when the annular force sensing device 3 is installed on a beam, and the beam is deformed by gravity and bent downward, the annular force sensing device with one force sensor 2 can measure the force applied to the beam. Furthermore, as shown in FIG. 5, when two force sensors 2 are positioned at each end in the diametrical direction within the internal space surrounded by the ring 31, the annular force sensing device 3 can detect the forces on the two ends in the diametrical direction. In another embodiment, when a plurality of force sensors 2 are installed on the inner surface of the ring 31, the direction and magnitude of the forces applied on the measured object O can be accurately determined by integrating the measurement results from all force sensors 2. The details of the embodiment will be described later.

In addition, the ring 31 of this embodiment is a C-shaped ring, but is not limited thereto. In another embodiment, when the measured object O is a large object, the ring 31 may also be formed by assembling a plurality of components, as described in the following embodiment. In addition, the shape of the ring 31 may be determined by the external profile of the measured object O, such as a circular ring, an elliptical ring, a square ring, or another multi-sided ring.

Refer to FIG. 6A and FIG. 6B. FIG. 6A illustrates a perspective view of an annular force sensing device 3 according to an embodiment of the disclosure. FIG. 6B illustrates a schematic diagram illustrating that the annular force sensing device 3 shown in FIG. 6A is applied to a wind turbine Wt. The following example shows how the annular force sensing device 3 can be used to measure the applied force acting on the pile (measured object O) of the wind turbine Wt. However, the application of the annular force sensing device 3 of the disclosure is not limited to this, and it can be applied to any measured object O that can be fitted with the ring 31, such as a beam, a cylinder, a pile, a column, a shaft, a bar, etc.

FIG. 6B shows three annular force sensing devices 3 configured on the pile (the measured object O) of a wind turbine Wt. These sensing devices can be configured to measure various applied forces acting on the wind turbine Wt, such as wind force Fw, the impact force Fz of the waves, and seismic force (not shown in the figure). When the wind turbine Wt is subjected to these applied forces, the three annular force sensing devices 3 may respectively measure forces acting on the upper, middle, and lower sections of the pile (the measured object O). Certainly, to obtain more accurate results, additional annular force sensing devices 3 may also be arranged on the pile.

Furthermore, as shown in FIG. 6A, the ring 31 of this embodiment includes two arches 311. Each of two ends of each arch 311 has a fastening portion 312. These fastening portions 312 of the arches 311 are connected adjacently to make the arches form the ring 31. In other words, the fastening portions 312 of the arch 311 are connected to the fastening portions 312 of the adjacent arch 311. However, it should be noted that the actual application is not limited to only two arches 311, and additional arches 311 may be used in response to an actual size of the measured object O.

In addition, in this embodiment, four force sensors 2 are arranged on the inner surface of the ring 31, and the surrounding distance on the inner surface of the ring 31 between two adjacent force sensors 2 is equal. The term “equal” mentioned here refers to a substantially equal value. It is intended that the associated numerical value includes a manufacturing or operational tolerance (e.g., ±10%) around the specified value. In other words, if a centroid of the ring 31 is used as the center of the circle, and a central angle θ between the two adjacent force sensors 2 is equal, as shown in FIG. 6A. In this way, by obtaining the values of the four forces obtained through these four force sensors 2, it is possible to determine whether the pile (the measured object O) is eccentric or not and is possible to determine the magnitudes and directions of the applied forces. In other embodiments, it is not limited to configuring force sensors 2 at equal surrounding distances on the inner surface of the ring 31. If a special requirement is proposed, such as a focus on the forces or deformations of the pile (measured object O) in a specific orientation, additional force sensors 2 can be disposed on the inner surface of the ring 31 corresponding to that specific orientation.

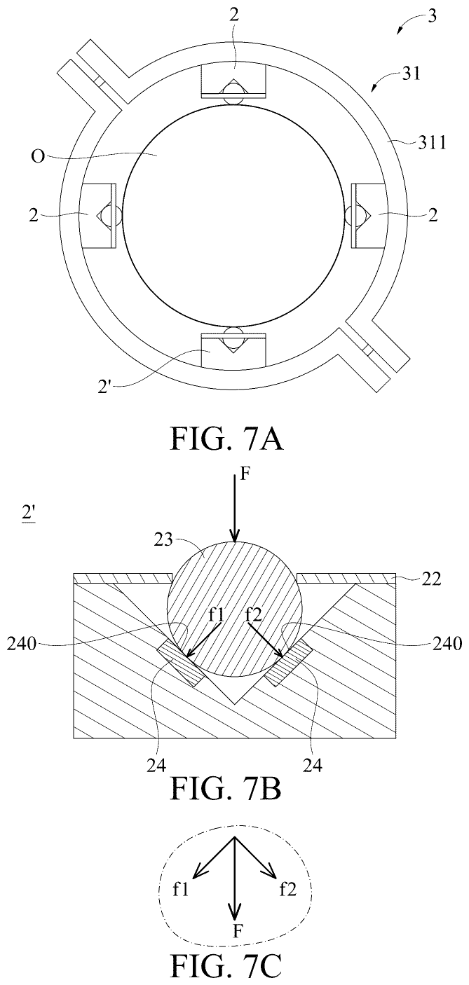

Refer to FIG. 7A, FIG. 7B, and FIG. 7C together. FIG. 7A illustrates a top view of the annular force sensing device 3 shown in FIG. 6B, where a measured object O (a pile) is presented as a section and is in a state of uniform deformation. FIG. 7B illustrates a cross-sectional view of a force sensor 2′ in the annular force sensing device 3 shown in FIG. 7A. FIG. 7C illustrates a schematic diagram illustrating the applied force F, the first component force f1, and the second component force f2 in FIG. 7B. As shown in FIG. 7A, when the pile (the measured object O) is deformed uniformly, the applied force F is applied on the force sensor 2′ in the normal direction. Therefore, the sensing members 24 measure forces of the same magnitude, and each force is applied in the normal direction of the sensing surface 240 of each sensing members 24. In other words, as shown in FIG. 7B and FIG. 7C, the magnitudes of the first component force f1 and the second component force f2 are the same which are applied to each sensing member 24 in a symmetrical manner (at an equal angle).

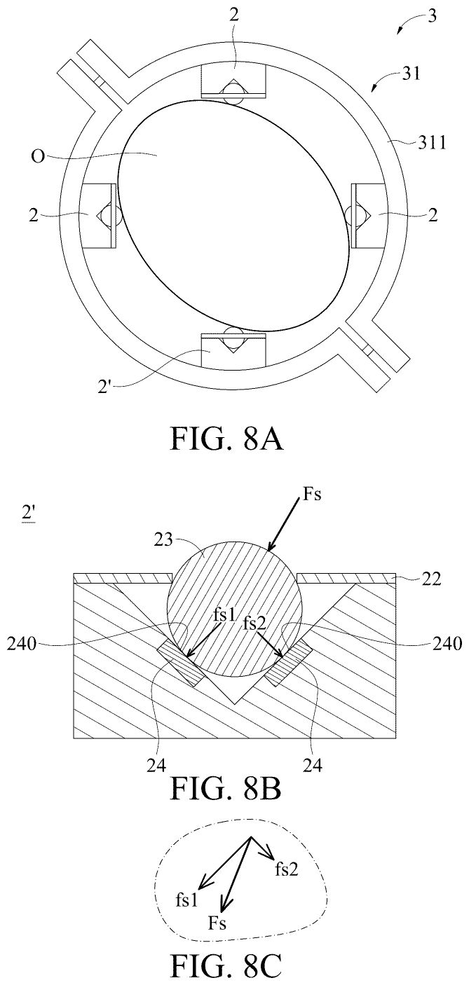

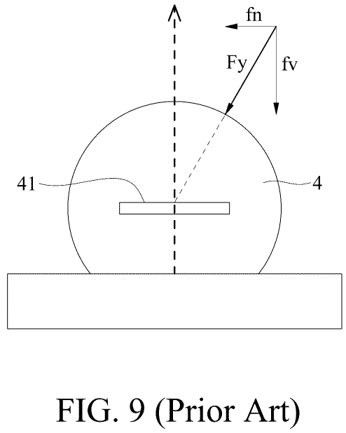

Refer to FIG. 8A, FIG. 8B, and FIG. 8C together. FIG. 8A illustrates a top view of the annular force sensing device 3 shown in FIG. 6B, where a measured object O (a pile) is presented as a section and is in a state of non-uniform deformation. FIG. 8B illustrates a cross-sectional view of a force sensor 2′ in the annular force sensing device 3 shown in FIG. 8A. FIG. 8C illustrates a schematic diagram illustrating the applied force Fs, the first component force fs1, and the second component force fs2 in FIG. 8B. When the pile (measured object O) undergoes bending and deformation due to an applied force (e.g., wind force), the magnitude and direction of the applied force Fs measured by each force sensor 2, 2′ will be different. By integrating the measurement results of all force sensors 2, 2′, the magnitude and direction of the applied force Fs can be determined. Furthermore, the degree of deformation of the pile (measured object O) can be further analyzed, and software can be used to simulate the deformation of the pile (measured object O).

Although the disclosure has been described in considerable detail with reference to certain preferred embodiments thereof, the disclosure is not limitative of the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A force sensor, comprising:
a bearing member comprising a multi-sided recess;
a restraint member with a through hole and coupled to the bearing member;
a contact member disposed in the multi-sided recess, wherein the contact member contacts a plurality of bearing surfaces of the multi-sided recess and has an exposed portion protruding from the through hole; and
a plurality of sensing members disposed on the plurality of bearing surfaces or disposed within the bearing member, wherein the plurality of sensing members correspond to the plurality of bearing surfaces, and each of the plurality of sensing members has a sensing direction perpendicular to a corresponding one of the plurality of bearing surfaces.

2. The force sensor according to claim 1, wherein the contact member is a sphere, and a normal direction of a sensing surface of each of the plurality of sensing members passes through a centroid of the sphere.

3. The force sensor according to claim 1, wherein the contact member comprises a first contact portion and a second contact portion configured for point contact with or line contact with the plurality of bearing surfaces of the bearing member; and a force applying portion configured for point contact with or line contact with a measured object.

4. The force sensor according to claim 2, wherein a diameter of the through hole of the restraint member is smaller than a diameter of the sphere.

5. The force sensor according to claim 3, wherein the plurality of bearing surfaces comprise two bearing surfaces, the multi-sided recess is a V-shaped groove; the first contact portion and the second contact portion respectively contact the two bearing surfaces of the V-shaped groove.

6. The force sensor according to claim 3, wherein the plurality of bearing surfaces comprise three bearing surfaces, the multi-sided recess is a three-sided pyramidal recess, the contact member further comprises a third contact portion; the first contact portion, the second contact portion, and the third contact portion respectively contact the three bearing surfaces of the three-sided pyramidal recess.

7. The force sensor according to claim 3, wherein the plurality of bearing surfaces comprise four bearing surfaces, the multi-sided recess is a four-sided pyramidal recess, the contact member further comprises a third contact portion and a fourth contact portion; the first contact portion, the second contact portion, the third contact portion, and the fourth contact portion respectively contact the four bearing surfaces of the four-sided pyramidal recess.

8. The force sensor according to claim 1, wherein the contact member is a cylinder or has a plurality of protrusions on the exposed portion of the contact member.

9. The force sensor according to claim 1, wherein each of the sensing members comprises a housing and a piezoelectric unit, and the piezoelectric unit is arranged within the housing, and the housing is disposed within the bearing member.

10. An annular force sensing device, comprising:
an ring; and
at least one force sensor arranged on an inner surface of the ring, wherein
each of the at least one force sensor comprises:
a bearing member comprising a multi-sided recess;
a restraint member with a through hole and coupled to the bearing member;
a contact member disposed in the multi-sided recess, wherein the contact member contacts a plurality of bearing surfaces of the multi-sided recess and has an exposed portion protruding from the through hole; and
a plurality of sensing members disposed on the plurality of bearing surfaces or disposed within the bearing member, wherein the plurality of sensing members correspond to the plurality of bearing surfaces, and each of the plurality of sensing members has a sensing direction perpendicular to a corresponding one of the plurality of bearing surfaces.

11. The annular force sensing device according to claim 10, wherein the annular force sensing device comprises a plurality of force sensors equidistantly arranged on the inner surface of the ring.

12. The annular force sensing device according to claim 10, wherein the ring comprises a plurality of arches, each of the plurality of arches comprises a fastening portion at both ends, and the fastening portions of the plurality of arches are adjacently connected to form the ring.

13. The annular force sensing device according to claim 10, wherein the contact member of the at least one force sensor is a sphere, and a normal direction of a sensing surface of each of the plurality of sensing members passes through a centroid of the sphere.

14. The annular force sensing device according to claim 13, wherein a diameter of the through hole of the restraint member of the at least one force sensor is smaller than a diameter of the sphere.

15. The annular force sensing device according to claim 13, wherein the contact member of the at least one force sensor comprises a first contact portion and a second contact portion configured for point contact with or line contact with the plurality of bearing surfaces of the bearing member; and a force applying portion configured for point contact with or line contact with a measured object.

16. The annular force sensing device according to claim 15, wherein the plurality of bearing surfaces comprise two bearing surfaces, the multi-sided groove is a V-shaped groove; the first contact portion and the second contact portion respectively contact the two bearing surfaces of the V-shaped groove.

17. The annular force sensing device according to claim 15, wherein the plurality of bearing surfaces comprise three bearing surfaces, the multi-sided groove is a three-sided pyramidal recess, the contact member further comprises a third contact portion; the first contact portion, the second contact portion, and the third contact portion respectively contact the three bearing surfaces of the three-sided pyramidal recess.

18. The annular force sensing device according to claim 15, wherein the plurality of bearing surfaces comprise four bearing surfaces, the multi-sided groove is a four-sided pyramidal recess, the contact member further comprises a third contact portion and a fourth contact portion; the first contact portion, the second contact portion, the third contact portion, and the fourth contact portion respectively contact the four bearing surfaces of the four-sided pyramidal recess.

19. The annular force sensing device according to claim 10, wherein the contact member of the at least one force sensor is a cylinder or has a plurality of protrusions on the exposed portion of the contact member.

20. The annular force sensing device according to claim 10, wherein each of the sensing members of the at least one force sensor comprises a housing and a piezoelectric unit, and the piezoelectric unit is arranged within the housing, and the housing is disposed within the bearing member.

21. A force sensor, comprising:
a bearing member comprising a plurality of bearing surfaces;
a plurality of sensing members respectively disposed on the plurality of bearing surfaces or disposed within the bearing member, wherein the plurality of sensing members correspond to the plurality of bearing surfaces, and each of the plurality of sensing members has a sensing direction perpendicular to a corresponding one of the plurality of bearing surfaces; and
a contact member comprising a plurality of contact portions configured for point or line contact with the plurality of bearing surfaces of the bearing member; and a force applying portion configured for contacting with a measured object.

22. The force sensor according to claim 21, wherein in response to a change in a direction of an applied force on the force applying portion, contact positions between the plurality of contact portions and the plurality of bearing surfaces remain unchanged.

23. The force sensor according to claim 21, wherein in response to an applied force being applied to the force applying portion, the plurality of sensing members are respectively configured to measure a plurality of component forces of the applied force, and the plurality of component forces are respectively perpendicular to the bearing surfaces corresponding to the plurality of sensing members.

24. The force sensor according to claim 23, wherein a resultant force of the plurality of component forces is equal to the applied force.

25. The force sensor according to claim 21, wherein an included angle is formed between each of the plurality of bearing surfaces and an adjacent one of the plurality of bearing surfaces.

26. The force sensor according to claim 25, wherein a number of the plurality of bearing surfaces comprise two bearing surfaces forming a V-shaped groove; the contact portions comprise a first contact portion and a second contact portion contacting the two bearing surfaces of the V-shaped groove.

27. The force sensor according to claim 25, wherein the included angle is ninety degrees.

28. The force sensor according to claim 21, wherein the contact member is a sphere, and a normal direction of a sensing surface of each of the plurality of sensing members passes through a centroid of the sphere.
